(19) United States
(12) Patent Application Publication
(10) Pub. No.: US 2025/0084193 A1
(43) Pub. Date: Mar. 13, 2025

(54) HIGH DENSITY POLYETHYLENE COMPOSITIONS AND ARTICLES THEREOF

(71) Applicant: ExxonMobil Technology and Engineering Company, Spring, TX (US)

(72) Inventors: Nino RUOCCO, Houston, TX (US); Haiqing PENG, Sugar Land, TX (US); Nilesh SAVARGAONKAR, Manvel, TX (US); Keith W. TRAPP, Kingwood, TX (US)

(21) Appl. No.: 18/784,035

(22) Filed: Jul. 25, 2024

Related U.S. Application Data
(60) Provisional application No. 63/582,441, filed on Sep. 13, 2023.

(51) Int. Cl. C08F 10/02; C08J 5/18

(52) U.S. Cl. CPC C08F 10/02; C08J 5/18; C08J 2323/06

(57) ABSTRACT

The present disclosure relates to polyethylene compositions, articles (e.g., films) including such polyethylene compositions, and methods of making polyethylene compositions and articles (e.g., films) thereof. The polyethylene composition comprises 80 wt % or greater ethylene-derived units; has density within the range from 0.940 to 0.975 g/cm3; a melt index (MI) of 0.1 to 3.0 g/10 min (such as 0.5 g/10 min to 2.5 g/10 min); a high load melt index (HLMI) within the range from 60 g/10 min to 150 g/10 min; a melt index ratio (MIR, defined as HILMI/MI) greater than 50; and has a crossover frequency (COF) according to the following relationship: COF>−0.00015*(Mw)+80 (where COF is in rad/s and Mw is weight-average molecular weight in g/mol).

### CROSS-REFERENCE TO RELATED APPLICATION

This application claims the benefit of U.S. Provisional Application 63/582,441 filed Sep. 13, 2023, entitled “HIGH DENSITY POLYETHYLENE COMPOSITIONS AND ARTICLES THEREOF”, the entirety of which is incorporated by reference herein.

### FIELD

The present disclosure relates to high density polyethylene compositions, articles including such polyethylene compositions, and methods of making polyethylene compositions and articles (e.g., films) thereof.

### BACKGROUND

High density polyethylenes (HDPE) are versatile resins. Their structures and properties can be tailored and made suitable for many fabrication processes and end use applications. For rigid parts. HDPE can be used for blow molded bottles, injection molded crates, extruded gas or water pipes, etc. HDPE can also be used in flexible packaging, such as grocery bags, compression packaging, stand-up pouch, where high holding force and stiffness are needed. HDPE may also be used for some niche applications such as package with good moisture barrier properties and orientability as well as extrudability: packages for cereal, coffee, tea, pet foods, etc.

It may also be used for packages that need higher heat resistance such as regular blown films or blown/cast machine direction oriented (MDO) films which are part of PE//PE laminates. Such films require polyethylene resins that fulfil many goals, some of which are traditionally seen as competing or outright contradictory. For example, incorporating high-crystallinity HDPE into blown film formulations can provide desirably greater stiffness, heat resistance, and moisture barrier (as shown by, e.g., low water vapor transmission rate (WVTR) and/or moisture vapor transmission rate (MVTR) per ASTM F1249); however, such HDPE also typically has rheology such that it is substantially more difficult to process in blown film production processes and equipment. For example, it is commonly understood that HDPE should have melt index (MI) of 2.0 or less in order to be suitable for blown film processing; however, higher MI (lower molecular-weight) HDPE provides greater crystallinity for the aforementioned desired stiffness, heat resistance, and moisture barrier. Furthermore, the lower comonomer content required for such HDPE resins also can lead to undesirably poor optical properties such as lower gloss and/or higher haze: and the poor relaxation of such resins can also lead to an undesired imbalance of film properties between machine direction (MD) and transverse direction (TD).

It remains challenging to find a resin that provides film, especially blown film, with good properties, good balance of MD and TD properties, all while maintaining good processability.

References of potential interest in this regard include: U.S. Pat. Nos. 9,309,338 B2; 9,505,161 B2; WO2021-041095.

### SUMMARY

In some embodiments, a method of making a polyethylene composition includes introducing ethylene, an optional comonomer, a diluent, a catalyst, and a cocatalyst to a loop reactor under conditions sufficient to produce a slurry comprising the polyethylene composition; continuously discharging a portion of the slurry from the loop reactor as effluent comprising the polyethylene composition; flashing the effluent to vaporize diluent and form a concentrated effluent comprising the polyethylene composition; and obtaining the polyethylene composition therefrom. The method can further include blending optional additives with the polyethylene composition. Optionally, the vaporized diluent may also be condensed.

Polyethylene compositions in accordance with various embodiments exhibit a unique blend of high MIR (and, ergo, good processability) while also having a relatively high crossover frequency (COF) for its molecular weight (especially weight-average molecular weight, Mw). Thus, the compositions of such embodiments may be characterized by one or more, preferably two or more, and most preferably all of the following: (1) density within the range from 0.940 to 0.975 g/cm³; (2) a melt index (MI, or I_{2.16}, measured at 2.16 kg loading and 190° C.) of 0.1 to 5 g/10 min, preferably 1.0 to 3.0 g/10 min, such as 0.5-2.5 g/10 min or 1.0-2.0 g/10 min; (3) a high load melt index (HLMI or I_{21.6}, measured at 21.6 kg loading and 190° C.) within the range from 60-150 g/10 min, preferably 70-100 g/10 min; (4) and a melt index ratio (MIR, defined as HLMI/MI) greater than 50, such as within the range from 50-100 (such as 60 to 70 or 60 to 80). The PE compositions can be further characterized by their rheology, and in particular their loss and storage moduli exhibited in oscillatory shear viscosity measurements may be such that the PE compositions have a crossover frequency (COF) in accordance with the equation COF>−0.00015*(Mw)+80 (where COF is in rad/s and Mw is weight-average molecular weight in g/mol), indicating the unique combination of molecular architecture and chain length of the PE compositions. The PE compositions are preferably unimodal, and can also exhibit one or more of the following additional properties: a weight-average molecular weight (Mw) of 80,000 g/mol to 300,000 g/mol (preferably 100,000 to 220,000 g/mol, such as 100,000 to 150,000 g/mol); a number-average molecular weight (Mn) of 5,000 g/mol to 30,000 g/mol (preferably 10,000 to 20,000 g/mol); a z-average molecular weight (Mz) of 700,000 to 3,000,000 g/mol (preferably 800,000 to 1,500,000 g/mol); an Mw/Mn value of 5 to 15; an M/Mw value of 5 to 15; an Mz/Mn value of 50 to 110; and a g′ value of 0.9 to 1.0. In addition, such compositions can comprise 80 wt % or greater ethylene-derived units and 0-20 wt % of units derived from comonomers, preferably C₃-C₂₀ α-olefin comonomers, most preferably 1-butene, 1-hexene, and/or 1-octene comonomers.

Various embodiments also include articles such as films made from the PE compositions. For example a film such as a blown film may include the PE compositions and have thickness within the range from 1 μm to 50 μm.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a graph illustrating crossover frequency (COF) vs. weight average molecular weight (Mw) of various example PE compositions, including PE compositions in accordance with various embodiments described herein.

### DETAILED DESCRIPTION

The present disclosure relates to polyethylene compositions, articles including such polyethylene compositions, and methods of making polyethylene compositions and articles (e.g., films) thereof.

In some embodiments, the present disclosure provides methods of making polyethylene compositions, such as unimodal HDPE compositions.

The polymerization may be carried out by using a ChevronPhillips Chemical slurry-loop type reactor, by using a chrome-based catalyst. Details of the chrome-based catalyst can be found at the following reference [Chapter 13. A Review of the Phillips Chromium Catalyst for Ethylene Polymerization. Handbook of Transition Metal Polymerization Catalysts, Second Edition. Edited by Ray Hoff. © 2018 John Wiley & Sons. Inc.]. The reactor temperature, ethylene C2 partial pressure, hydrogen H2 partial pressure and other reactors were manipulated to prepare comparative and inventive samples. The operation of this type of reactors is known to skilled persons in the art.

The films can provide such advantages with relatively thin thickness, providing advantageous use as food packaging.

### Definitions and Test Methods

The term “polyethylene” refers to a polymer having at least 50 wt % ethylene-derived units, such as at least 70 wt % ethylene-derived units, such as at least 80 wt % ethylene-derived units, such as at least 90 wt % ethylene-derived units, or at least 95 wt % ethylene-derived units, or 100 wt % ethylene-derived units. The polyethylene can thus be a homopolymer or a copolymer, including a terpolymer, having one or more other monomeric units. A polyethylene described herein can, for example, include at least one or more other olefin(s) and/or comonomer(s).

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 50 wt % to 55 wt %, it is understood that the mer unit in the copolymer is derived from ethylene in the polymerization reaction and said derived units are present at 50 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically.

The term “alpha-olefin” or “x-olefin” refers to an olefin having a terminal carbon-to-carbon double bond in the structure thereof R¹R²C═CH₂, where R¹ and R² can be independently hydrogen or any hydrocarbyl group; such as R¹ is hydrogen and R² is an alkyl group. A “linear alpha-olefin” is an alpha-olefin wherein R¹ is hydrogen and R² is hydrogen or a linear alkyl group.

For the purposes of the present disclosure, ethylene shall be considered an α-olefin.

When a polymer or copolymer is referred to herein as comprising an alpha-olefin (or α-olefin), including, but not limited to ethylene, 1-butene, and 1-hexene, the olefin present in such polymer or copolymer is the polymerized form of the olefin. For example, when a polymer is said to have an “ethylene content” or “ethylene monomer content” of 80 to 99.9 wt %, or to comprise “ethylene-derived units” at 80 to 99.9 wt %, it is understood that the mer unit in the copolymer is derived from ethylene in the polymerization reaction and said derived units are present at 80 to 99.9 wt %, based upon the weight of ethylene content plus comonomer content.

As used herein, and unless otherwise specified, the term “Cn” means hydrocarbon(s) having n carbon atom(s) per molecule, wherein n is a positive integer.

Various measurements described herein may be based on certain standardized testing procedures. For example, measurements of tensile strength in the machine direction (MD) and transverse direction (TD) can be made by following the procedure of ASTM D882. Measurements of yield strength in MD and TD can be made by following the procedure of ASTM D882. Measurements of Elmendorf tear strength in MD and TD can be made by following the procedure of ASTM D1922-09.

Melt index (MI, 2.16 kg loading; also referred to as I_{2.16}) and high-load melt index (HLMI, 21.6 kg loading; also referred to as I_{21.6}) values can be determined according to ASTM D1238-13 procedure B, such as by using a Gottfert MI-2 series melt flow indexer. Melt index ratio (MIR) is the ratio HLMI/MI. For MI, HLMI, and MIR values reported herein, testing conditions were set at 190° C. and 2.16 kg (MI) and 21.6 kg (HMLI) load. An amount of 5 g to 6 g of sample is loaded into the barrel of the instrument at 190° C. and manually compressed. Afterwards, the material is automatically compacted into the barrel by lowering all available weights onto the piston to remove all air bubbles. Data acquisition is started after a 6 min pre-melting time. Also, the sample is pressed through a die of 8 mm length and 2.095 mm diameter.

Density herein is measured according to ASTM D1505-19 (gradient density) using a density-gradient column on a plaque. The plaque is molded according to ASTM D4703-10a, procedure C, and the plaque is conditioned for at least 40 hours at 23° C. to approach equilibrium crystallinity in accordance with ASTM D618-08.Melting point was measured according to ASTM D3418, the peak temperature of the 2nd melt is reported.

Rheological data such as complex viscosity, storage and loss modulus, phase angle, and the like, can be determined using SAOS (small amplitude oscillatory shear) testing. SAOS experiments is performed at 190° C. using a 25 mm parallel plate configuration on an ARES-G2 (TA Instruments). Sample test disks (25 mm diameter, 1.5 mm thickness) can be made with a Carver Laboratory press at 190° C. Samples are allowed to sit without pressure for approximately 3 minutes in order to melt and then held under pressure typically for 3 minutes to compression mold the sample. The disk sample is first equilibrated at 190° C. for about 5 minutes between the parallel plates in the rheometer to erase any prior thermal and crystallization history. An angular frequency sweep is next performed with a typical measurement gap of 1.5 mm from 628 rad/s to 0.01 rad/s angular frequency using 5 points/decade and a strain value within the linear viscoelastic region determined from strain sweep experiments (see C. W. Macosko, Rheology Principles, Measurements and Applications, Wiley-VCH, New York, 1994), preferably about 5% strain during the testing. All experiments are performed in a nitrogen atmosphere to minimize any degradation of the sample during the rheological testing.

The complex viscosity |η*(ω)| versus frequency (ω) data obtained for the SAOS experiment is fitted using the Carreau-Yasuda (CY) model to obtain the zero-shear viscosity η0. The TA instrument TRIOS software may be used for convenience to analyze the SAOS data. The Carreau Yasuda model is below, where η₀ is the zero-shear viscosity, k is the consistency (characteristic time), n is the power law index and a parameter that describes the transition between Newtonian plateau and power law region. ηₒₒ is the infinite viscosity and fixed at 0 for the analysis.

$$\frac{η - {η}_{∞}}{{η}_{0} - {η}_{∞}} = {[ 1 + {( k \dot{γ} )}^{a} ]}^{\frac{n - 1}{a}}$$

The Carreau-Yasuda model analysis is a built-in method in the TRIO software that can be conveniently conducted after Cox-Merz transformation which is also a built-in method in the TRIO software.

By definition cross over frequency (COF) is the angular frequency where storage modulus G′ and loss modulus G″ are equal in a frequency sweep. In general, higher crossover frequency means shorter relaxation time for the molecule, and it is frequently associated lower Mw (weight-average molecular weight). The COF can be determined in connection with the above-described SAOS experiment, by plotting both (1) measured storage modulus (G′) as a function of angular frequency and (2) measured loss modulus as a function of angular frequency (G″), and identifying the angular frequency value at which the two functions (G′ and G″) are equal. This can conveniently be done using the TRIOS software (TA Instruments) by conducting the modulus crossover analysis feature that is built-in to the software.

Molecular weight data for z-average, number-average, and weight-average molecular weight (Mz, Mn, and Mw, respectively) and co-monomer distribution can be determined according to GPC method. In particular, the values are obtained by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10 μm Mixed-B LS columns are used to provide polymer separation. Detailed analytical principles, parameters and methods are described in WO2019246069A1. Unless otherwise specifically mentioned, all the molecular weight moments used or mentioned herein (including, e.g., the Mz, Mn, Mw values) are based on the light-scattering (LS), otherwise known as the “absolute”, determination method (e.g., as referenced in Paragraph of WO2019-246069A1, noting that w2 is 0 for polyethylene homopolymer, such that dn/dc=0.1048). Where otherwise specifically mentioned as the “conventional” method, or IR molecular weight, determination is according to the description of Paragraphs [0044]-[0045] of the just-noted publication, noting that for the equation in such Paragraph [0044], a=0.695 and K=0.000579 (1-0.75 Wt) are used, where Wt is the weight fraction for hexane comonomer, and further noting that comonomer composition is determined by the ratio of the IR5 detector intensity corresponding to CH₂ and CH₃ channel calibrated with a series of PE and PP homo/copolymer standards whose nominal values are predetermined by NMR or FTIR (providing methyls per 1000 total carbons (CH₃/1000 TC)) as noted in Paragraph [0045] of the just-noted PCT publication).

On the other hand, g′ is obtained in accordance with the methods described in Paragraphs [0048]-[0051] of PCT Publication WO2019/246069A1.

Unsaturated information was by a 1H-NMR spectroscopy. 1H NMR data of the polymer was collected at 120° C. using a 10 mm cryoprobe on a 600 MHz Bruker spectrometer with 1,1,2,2-tetrachloroethane-d2 (tce-d2). Samples were prepped with a concentration of 30 mg/mL at 140° C. Data was recorded with a 30° pulse, 5 second delay, 512 transients. Signals were integrated and the numbers of unsaturation types per 1000 carbons were reported. The shift regions used for unsaturations in the examples are noted in Table 1.

TABLE 1
Shift regions for unsaturation data

| | Shift | Number | |
|---|---|---|---|
| | Region | of hydrogens | |
| Species | (ppm) | per structure | Calculation |
| Vinyl | 4.95-5.10 | 2 | (Vinyl/2)*1000/(total) |
| Vinylidene | 4.70-4.84 | 2 | (Vinylidene/2)*1000/(total) |
| Vinylene | 5.31-5.55 | 2 | (Vinylene/2)*1000/(total) |
| Trisubstituted | 5.11-5.30 | 1 | (trisub/1)*1000/(total) |
| Aliphatic | 0-2.1 | 2 | Aliphatic/2 |
| Total | | | Vinyl + vinylidene + |
| | | | vinylene + trisub*2 + |
| | | | aliphatic/2 |

The “secant modulus” is the slope of a line connecting the origin to an object's stress/strain curve at a specified strain percentage. For example, the “1% secant modulus” is the slope of a line connecting the origin to an object's stress/strain curve at 1% strain. The secant modulus describes the overall stiffness of an object. Lower strain percentages typically approximate elastic behavior more accurately.

The term “tensile strength” refers to the stretching force required to inelastically deform a material. The tensile strength of a material can be measured by stretching the material in MD or TD. Tensile strength is measured in psi and can be tested via ASTM D882-10.

Water vapor transmission rate (WVTR) was performed according to ASTM F1249 at 37.8° C. with 100% relative humidity. Oxygen transmission rate (OTR) was performed according to ASTM F2622 at 23.0° C. with 100% O2 and 0 relative humidity.

### Polyethylene Compositions

Provided herein are polyethylene compositions, and especially high density polyethylene (HDPE) compositions that exhibit good processability (especially in film extrusion processes such as blown film extrusion) and a unique combination of high melt index ratio (MIR) and rheology such that the HDPE compositions have high crossover frequency (COF) relative to their weight-average molecular weight. Such rheology, indicated by high COF vs Mw; is suggestive of maintaining a good balance of properties in films made from such HDPE compositions, particularly with respect to machine direction (MD) vs. transverse direction (TD) properties.

For example, the polyethylene compositions may include polyethylene homopolymers, or copolymers of units derived from ethylene and units derived from one or more C₃ to C₄₀ olefin comonomers, such as C₃ to C₂₀ α-olefin comonomers (e.g., propylene, 1-butene, 1-hexene, 1-octene, 1-decene, 1-dodecene, such as propylene, 1-butene, 1-hexene, 1-octene, or a mixture thereof; such as 1-butene and/or 1-hexene).

The polyethylene compositions may include the ethylene-derived units in an amount of at least 80 wt %, or 85 wt %, such as at least 90, 95, 96, 97, 98, or 99 wt % (for instance, in a range from a low of 80, 85, 90, 95, 98, 99.0, 99.1, 99.2, 99.3, or 99.4 wt %, to a high of 96, 97, 98.1, 98, 98.2, 98.3, 98.4, 98.5, 98.6, 98.7, 98.8, 98.9, 99.0, 99.1, 99.2, 99.3, 99.4, 99.5, 99.6, 99.7, 99.8, or 99.9 wt %, with ranges from any foregoing low value to any foregoing high value contemplated, provided the high is greater than the low), on the basis of mass of all monomer-and comonomer-derived units in the polyethylene composition. For instance, the polyethylene composition may include 95, 98, 98.5, 99, 99.1, 99.2, or 99.3 to 99.9 wt % ethylene-derived units, or it may include 100 wt % ethylene-derived units (e.g., homopolyethylene). Comonomer units (e.g., C₃ to C₂₀ α-olefin-derived units, such as units derived from 1-butene, 1-hexene, and/or 1-octene) may be absent (e.g., 0 wt %), or they may be present in the polyethylene composition within the range from a low of 0.0, 0.1, 0.2, 0.3, 0.4, 0.5, 0.6, 0.7, 0.8, 0.9, 1.0, 2.0, 3.0, 4.0, or 5.0 wt %, to a high of 0.7, 0.8, 0.9, 1, 1.1, 1.2, 1.3, 1.4, 1.5, 1.6, 1.7, 1.8, 1.9, 2, 3, 4, 5, 10, 15, or 20 wt %, with ranges from any foregoing low values to any foregoing high values contemplated, provided the high is greater than the low value). For instance, the polyethylene composition may include 0-20 wt % comonomer, such as 0.1 wt % to 0.7, 0.8 0.9, 1.0, 1.5, or 5.0 wt % comonomer units.

Several suitable comonomers were already noted, although in various embodiments, other α-olefin comonomers are contemplated. For example, the α-olefin comonomer can be linear or branched, and two or more comonomers can be used, if desired. Examples of suitable comonomers include linear C₃-C₂₀ α-olefins (such as butene, hexene, octene as already noted), and α-olefins having one or more C₁-C₃ alkyl branches, or an aryl group. Specific examples include propylene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. It should be appreciated that the list of comonomers above is merely exemplary, and is not intended to be limiting. In some embodiments, comonomers include propylene, 1-butene, 1-pentene, 4-methyl-1-pentene, 1-hexene, 1-octene and styrene.

### Polyethylene Composition—Molecular Characteristics

A polyethylene composition according to various embodiments can have a density of 0.940 to 0.975 g/cm³, such as 0.950 to 0.965 g/cm³. For example, ethylene polymers may have a density from a low value of 0.940, 0.945, 0.950, 0.952, 0.953, 0.954, or 0.955 g/cm³ to a high value of 0.957, 0.958, 0.959, 0.960, 0.965, 0.970 or 0.975 g/cm³, with ranges of various embodiments including any combination of any upper or lower value disclosed herein.

In various embodiments, the polyethylene composition has one or more, two or more, or all of the following molecular weight properties:
weight-average molecular weight (Mw) of 80,000 to 300,000, such as from a low value of any one of 90,000 g/mol; 100,000 g/mol; 110,000 g/mol; 120,000 g/mol; 130,000 g/mol; 140,000 g/mol; 150,000 g/mol; and 160,000 g/mol, to a high value of any one of 160,000 g/mol; 170,000 g/mol; 180,000 g/mol; 190,000 g/mol; 200,000 g/mol; 210,000 g/mol; 220,000 g/mol; 225,000 g/mol; 250,000 g/mol; and 300,000 g/mol. Ranges from any one of the foregoing low values to any one of the high values are contemplated in various embodiments, provided the high value is greater than the low value. For example, Mw can be within the range from 90,000 to 250,000 g/mol in particular embodiments, such as 100,000 to 220,000 g/mol; or 110,000 g/mol to 130,000; 180,000; 200,000; or 225,000 g/mol.
number-average molecular weight (Mn) generally within the range from 5,000 to 30,000, such as from a low value of any one of 5,000 g/mol; 6,000 g/mol; 7,000 g/mol; 8,000 g/mol; 9,000 g/mol; or 10,000 g/mol; to a high value of any one of 11,000 g/mol; 12,000 g/mol; 13,000 g/mol; 14,000 g/mol; 15,000 g/mol; 17,500 g/mol; 20,000 g/mol; 22,500 g/mol; 25,000 g/mol; 27,500 g/mol; and 30,000 g/mol. Ranges from any one of the foregoing low values to any one of the high values are contemplated in various embodiments (for instance, Mn may be 10,000 to 20,000 g/mol; or 15,000 g/mol to 30,000 g/mol, such as 16,000 or 20,000 g/mol to 30,000 or 25,000 g/mol). More generally, in some embodiments, Mn may be 30,000 g/mol or less, such as 25,000 g/mol or less or 20,000 g/mol or less.
Z-average molecular weight (Mz) of 700,000 to 3,000,000 g/mol, such as from a low value of any one of 700,000 g/mol; 800,000 g/mol; 900,000 g/mol; 1 million g/mol; or 1.1 million g/mol, to a high value of any one of 1.2 million g/mol; 1.3 million g/mol; 1.4 million g/mol; 1.45 million g/mol; 1.5 million g/mol; 1.6 million g/mol; 1.65 million g/mol; 1.7 million g/mol; 1.75 million g/mol; 1.8 million g/mol; 1.85 million g/mol; 1.9 million g/mol; 1.95 million g/mol; 2 million g/mol; 2.5 million g/mol; 2.75 million g/mol; and 3 million g/mol. Ranges from any one of the foregoing low values to any one of the high values are contemplated in various embodiments (for instance, Mz may be 800,000 to 1.5 million g/mol, such as 900,000 to 1.2 million g/mol; or 1 million to 3million g/mol, such as 1.5 million to 3 million g/mol. In particular embodiments, Mz may be at least 800,000 g/mol, such as at least 900,000 g/mol, or at least 1 million g/mol.

Furthermore, polyethylene compositions in accordance with various embodiments may have Mw/Mn value (sometimes also referred to as polydispersity index (PDI) or molecular weight distribution (MWD)) of 5, 6, 7, 8, 9, 10, or 11 to 12, 12.5, 13, 14, 15, 16, 17, 18, 19, or 20 (with ranges from any low value to any high value contemplated, such as Mw/Mn from 9 to 12, or 10 to 11). In some embodiments, Mz/Mw ratio of the polyethylene compositions of various embodiments can be 5, 6, 7, 8, or 9 to 7.5, 8, 9, 10, 11, 12, 13, 14, or 15 (with ranges from any low value to any high value contemplated, such as Mz/Mw of 6 to 11, such as 7 to10, alternatively 7.5 to 9). Mz/Mn ratio (indicating the broadness of the overall distribution of molecular weights among chains within the polymer by considering the two characteristic values of very high molecular-weight chains (Mz) and very low molecular-weight chains (Mn)) may be 50, 60, 65, 70, 75, 80 to 85, 90, 95, 100, 105, 110, (with ranges from any low value to any high value contemplated, such as Mz/Mn of 50 to 75, such as 55 to 70, such as 60 to 70). In some embodiments, Mz/Mw ratio may be at least 6, 7, 8, 9, or 10. Similarly, in some embodiments, M/Mn ratio may be at least 55, or at least 60.

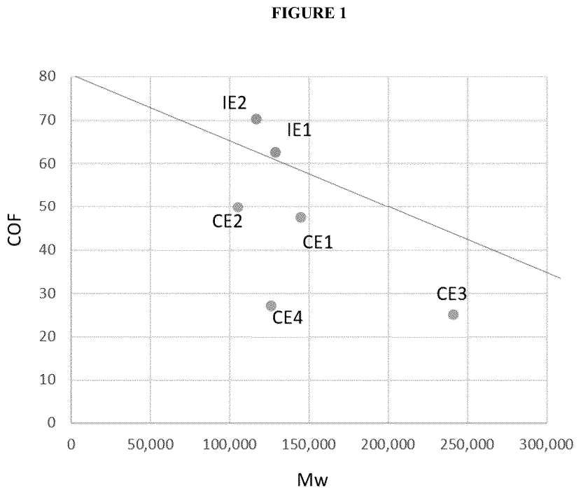

Furthermore, as noted, the polyethylene compositions of various embodiments described herein exhibit unimodal molecular weight distribution, meaning that there is a single distinguishable peak in a molecular weight distribution curve of the composition (as determined using gel permeation chromatography (GPC) or other recognized analytical technique, noting that if there is any conflict between or among analytical techniques, a molecular weight distribution determined by GPC, as described below; shall control). Examples of “unimodal” molecular weight distribution can be seen in U.S. Pat. No. 8,691,715, FIG. 6 of such patent, which is incorporated herein by reference. This is in contrast with a “multimodal” molecular weight distribution, which means that there are at least two distinguishable peaks in a molecular weight distribution curve (again, as determined by GPC or any other recognized analytical technique, with GPC controlling in the event of any conflict). For example, if there are two distinguishable peaks in the molecular weight distribution curve such composition may be referred to as bimodal composition. For example, in the '715 Patent, FIGS. 1-5 of that Patent illustrate representative bimodal molecular weight distribution curves. In these figures, there is a valley between the peaks, and the peaks can be separated or deconvoluted. Often, a bimodal molecular weight distribution is characterized as having an identifiable high molecular weight component (or distribution) and an identifiable low molecular weight component (or distribution). Bimodal Polyethylene can also refer to a PE compositions made from staged series reactors, or using mixed catalysts in a single reactor, to produce a blend of 2 different compositions, even though the GPC of such blend may appear to have only one peak.

### Other Rheological Properties

In various embodiments, the polyethylene compositions have melt index, (MI, also referred to as I₂ or I_{2.16} in recognition of the 2.16 kg loading used in the test) of 0.1 g/10 min to 5 g/10 min, such as from a low of any one of 0.1, 0.2, 0.25, and 0.3 g/10 min, to a high of 0.5, 0.55, 0.6, 0.65, 0.7, 0.75, 1, 1.2, 1.3, 1.4, 1.5, 1.7, 2, 2.5, 3, 4, 5, or 10 g/10 min, with ranges from any of the foregoing low values to any of the foregoing high values contemplated herein (e.g., 0.1 to 2.5 g/10 min, alternatively 0.5 to 2 or 2.5 g/10 min, such as 0.8 to 1.7 g/10 min, or 1.0 to 2.0 g/10 min). Moreover, polyethylene compositions of various embodiments can have a high load melt index (HLMI) (also referred to as I₂₁ or I_{21.6} in recognition of the 21.6 kg loading used in the test) of a low of 45, 50, 55, 60, 65, or 70 g/10 min to a high of 75, 80, 85, 90, 95, or 100 g/10 min; with ranges from any of the foregoing lows to any of the foregoing highs contemplated herein (e.g., 50 to 100 g/10 min, such as 70 to 90 g/10 minor 70 to 100 g/10 min).

MIR and Mw/Mn values provide information about the molecular weight distribution of the polymer chains that make up the polymer composition. However, MIR tends to be more sensitive to features of the polymer chains that impact the composition's rheology; and Mw and Mn as determined by GPC, on the other hand, are not so sensitive to rheological features of the polymer chains. Polyethylene compositions according to various embodiments may have a melt index ratio (MIR, defined as I_{21.6}/I_{2.16}) within the range from a low of any one of 40, 45, 50, 55 or 60 to a high of 65, 70, 75, 80, 90, or 100; with ranges from any of the foregoing lows to any of the foregoing highs contemplated herein (e.g., 40 or 50 to 80 or 100, such as 50 to 100 or 60 to 80).

In various embodiments, the polyethylene composition exhibits shear-thinning rheology, meaning that for increasing shear rates, viscosity decreases. But, advantageously, even at low shear rates (less than 1 rad/s, such as less than 0.5 rad/s, such as at 0.1 and 0.01 rad/s), the complex viscosity of the polyethylene compositions of such embodiments is relatively low. This rheology indicates good processability for the polyethylene compositions in accordance with such embodiments (insofar as the shear rates simulate the viscosity that the composition may exhibit when processed in extruders or similar equipment). Accordingly, a polyethylene composition according to various embodiments may exhibit one or more, such as two or more, or even all, of the following rheological properties:
Complex viscosity (at 628 rad/s, 190° C.) of 600, 550, 500, 400, or 350 Pa*s or less; such as within the range of a low of 100, 200, 225 or 250 Pa*s to a high of 300, 350, 400, 450, 500, 550, or 600 Pa*s, with ranges from any of the foregoing low values to any of the foregoing high values contemplated in various embodiments (provided the high value is greater than the low value) (e.g., 100 to 600 Pa*s, such as 200 to 400 Pa*s).
Complex viscosity (at 100 rad/s, 190° C.) of 2,500 Pa*s or less; such as 2,000 Pa*s or less; 1,500 Pa*s or less; 1,200 Pa*s or less; or 1,000 Pa*s or less; such as a low of 300; 400; 500; 600; 700 or 750 to a high of 800; 850; 900; 950; 1000; or 1,500 Pa*s, with ranges from any low value to any high value contemplated herein (provided the high value is greater than the low value) (e.g., 600 to 1,000 Pa*s, alternatively 700 to 900 Pa*s).
Complex viscosity (at 0.01 rad/s, 190° C.) of 40,000 Pa*s or less; such as 35,000 Pa*s or less; or 30,000 Pa*s or less; 27,500 Pa*s or less; or in some cases a low of 4,000; 5,000; 10,000; 12,000; 18,000; or 20,000 Pa*s to a high of 22,000; 25,000; 27,500; 30,000; 35,000; 37,000; or 40,000 Pa*s, with ranges from any low value to any high value contemplated herein (provided the high value is greater than the low value) (e.g., 18,000 to 35,000 Pa*s, alternatively 20,000 to 30,000 Pa*s).

Furthermore, the PE compositions may exhibit relatively high crossover frequency (COF) for their given Mw, as noted previously. In particular, they may follow the relationship: COF>−0.00015*(Mw)+80, where COF is crossover frequency in rad/s and Mw is weight-average molecular weight in g/mol. The constant −0.00015 has units rad/s/(g/mol); and the constant value 80 has units rad/s. See FIG. 1 and its accompanying discussion in connection with the Examples described herein, infra.

Methods of Making Polyethylene Compositions Polymerization processes of the present disclosure may be carried out in any suitable manner known in the art. Any suspension, homogeneous, bulk, solution, slurry, or gas phase polymerization process known in the art may be used. Such processes can be run in a batch, semi-batch, or continuous mode. A homogeneous polymerization process is defined to be a process where at least about 90 wt % of the product is soluble in the reaction medium. A bulk process is defined to be a process where monomer concentration in all feeds to the reactor is 70 volume % or more. Alternately, no solvent or diluent is present or added in the reaction medium, (except for the small amounts used as the carrier for the catalyst system or other additives, or amounts typically found with the monomer; e.g., propane in propylene).

In particular embodiments, the process is a slurry polymerization process, preferably a continuous slurry loop polymerization reaction process. A single slurry loop reactor may be used, or multiple reactors in parallel or series (although, to achieve the unimodal molecular weight distribution in accordance with various embodiments, as discussed previously, it is preferable that either a single reactor is used, or that the same catalyst, feed, and reaction conditions are used in multiple reactors, e.g., in parallel, such that the composition is considered made in a single reactive step). As used herein, the term “slurry polymerization process” means a polymerization process in which a supported catalyst is used and monomers are polymerized on the supported catalyst particles within a liquid medium (comprising, e.g., inert diluent and unreacted polymerizable monomers), such that a two phase composition including polymer solids and the liquid circulate within the polymerization reactor. Typically, a slurried tank or slurry loop reactor may be used; in particular embodiments herein, a slurry loop reactor is preferred. In such processes the reaction diluent, dissolved monomers, and catalyst are circulated in a loop reactor in which the pressure of the polymerization reaction is relatively high. The produced solid polymer is also circulated in the reactor. A slurry of polymer and the liquid medium may be collected in one or more settling legs of the slurry loop reactor from which the slurry is periodically discharged to a flash chamber wherein the mixture is flashed to a comparatively low pressure; as an alternative to settling legs, in other examples, a single point discharge method may be used to move the slurry to the flash chamber. The flashing results in substantially complete removal of the liquid medium from the polymer, and the vaporized polymerization diluent (e.g., isobutane) is then recompressed in order to condense the recovered diluent to a liquid form suitable for recycling as liquid diluent to the polymerization zone. The cost of compression equipment and the utilities required for its operation often amounts to a significant portion of the expense involved in producing polymer.

Slurry polymerization processes suitable for achieving such embodiments are described in, e.g., U.S. Pat. No. 6,204,344, col. 8, line 30 to col. 9, line 48 & FIG. 1, which portions are incorporated by reference herein; the entirety of the '344 patent is incorporated by reference herein in jurisdictions where such incorporation is permitted. More generally, the '344 patent describes an embodiment of a slurry polymerization system that includes a two-stage flash system for diluent recovery and recycling and associated methods for diluent recovery and recycling. The '344 patent discloses, inter alia, an apparatus for continuously recovering polymer solids from a polymerization effluent comprising a slurry of said polymer solids in a liquid medium comprising an inert diluent and unreacted monomers, which apparatus may be employed in embodiments in accordance with the present disclosure (although other slurry polymerization systems and apparatus may just as well be employed in accordance with various other embodiments). The apparatus described in the '344 patent comprises a discharge valve on a slurry reactor, examples of which include slurry loop reactors and stirred tank slurry reactors, for the continuous discharge of a portion of the slurry reactor contents into a first flash tank. The first flash tank operates at a pressure and slurry temperature such that a substantial portion of the liquid medium will be vaporized and the inert diluent component of said vapor is condensable, without compression, by heat exchange with a fluid. The first flash tank is in fluid communication with a second flash tank via a pressure seal that allows plug flow of a concentrated slurry into a second flash tank that operates at a temperature of the concentrated polymer solids/slurry and pressure such that any remaining inert diluent and/or unreacted monomer will be vaporized and removed overhead for condensation by compression and heat exchange and the polymer solids are discharged from the bottom of said second flash tank for additional processing or storage. A complete polymer production plant will include a number of these and other components (e.g., components for handling solids, liquids and gases, such as but not limited to separator systems such as cyclones and accumulator drums; pumps; sensors or meters of flow, pressure, and/or temperature; and the like), which are not described in detail herein. Unless otherwise described herein, such components are considered to be known in the art.

The liquid diluent employed in the polymerization medium is typically an alkane having from 3 to 7 carbon atoms. The medium employed should be liquid under the conditions of polymerization and relatively inert. In some embodiments, a branched alkane is a preferred diluent. In further embodiments, a hexane or an isobutane diluent is employed. More generally, suitable diluents/solvents for polymerization include non-coordinating, inert liquids. Non-limiting examples generally include straight and branched-chain hydrocarbons, such as isobutane, butane, pentane, isopentane, hexane, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C4 to C10 alkanes, chlorobenzene, and aromatic and alkyl substituted aromatic compounds, such as benzene, toluene, mesitylene, and xylene. Suitable solvents also include liquid olefins which may act as monomers or comonomers including, but not limited to, ethylene, propylene, 1-butene, 1-hexene, 1-pentene, 3-methyl-1-pentene, 4-methyl-1-pentene, 1-octene, 1-decene, and mixtures thereof. In some preferred embodiments, aliphatic hydrocarbon solvents are used as the solvent, such as isobutane, butane, pentane, isopentane, hexane, isohexane, heptane, octane, dodecane, or mixtures thereof; cyclic and alicyclic hydrocarbons, such as cyclohexane, cycloheptane, methylcyclohexane, methylcycloheptane, or mixtures thereof.

Preferred polymerization processes may be run at any temperature and/or pressure suitable to obtain the desired polyolefins. In particular embodiments, the polyethylene compositions are produced in a slurry reactor (e.g., slurry tank or slurry loop, preferably slurry loop) maintained at temperatures within the range from 80 to 110° C., such as 82 to 108° C., 95 to 105° C. or 100 to 105° C.; or 95 to 110° C. Reactor pressure may be within the range from 425 to 800 psig (2930 to 5516 kPa), such as from 450 to 650 psig (3102 to 4481 kPa); or 500 to 600 psig (3447 to 4137 kPa).

In another class of embodiments, the polymerization processes are gas phase polymerization processes. Generally, in a fluidized gas bed process used for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. Typically, the gas phase reactor may operate in condensing mode where one or more of the diluents/solvents, as described above, act as an inert condensing agent (ICA) in the fluidized bed reactor for the removal of heat to increase production rates and/or modify polymer properties. See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228.

### Catalyst

As noted, suitable polymerization processes employ a polymerization catalyst. The catalyst, for example, would preferably include chromium, chromium-containing, or chromium-based catalysts. Chromium, chromium-containing, or chromium-based catalysts are well-known and find utility for the polymerization of polyolefin polymers. Examples of two widely used catalysts include chromium oxide (CrO₃) and silylchromate catalysts. optionally, with at least one support. Chromium-containing catalysts have been the subject of much development in the area of continuous fluidized-bed gas-phase and slurry polymerization for the production of polyethylene polymers. Such catalysts and polymerization processes have been described, for example, in U.S. Patent Application Publication No. 2011/0010938 and U.S. Pat. Nos. 2,825,721, 7,915,357, 8,129.484, 7,202,313, 6,833,417, 6,841,630, 6,989,344, 7,504,463, 7,563,851, 8,420,754, and 8,101,691.

Typically, the catalyst system includes a supported chromium catalyst; it may also include an optional cocatalyst or activator. In general, one such catalyst includes a chromium compound supported on an inorganic oxide matrix. Typical supports include silicon, aluminum, zirconium and thorium oxides, as well as combinations thereof. Various grades of silica and alumina support materials are widely available from numerous commercial sources.

In a particular embodiment, the support is silica. Suitable silica generally has a good balance of a high surface area and large particle size. These silicas are typically in the form of spherical particles obtainable by a spray-drying process, or in the form of granular particles by a milling method, and have a surface area of about at least 300 m²/g and an average particle size at least 25 microns. Methods for measuring surface area, pore volume, and average particle size are disclosed in WO 2011/161412. For production of higher molecular weight HDPE, higher surface areas of about 500-600 m²/g are typically used along with modification with Al or Ti.

In several classes of embodiments, the silica support is rigid and has a large particles size at an average of about 90-110 microns and a high surface area extending up to at least 800 m²/g. See, for example, WO 2011-161412. Without being bound to theory, the high surface area promotes the formation of a high molecular weight component that provides improved physical polymer properties, especially stress crack resistance for high load melt index products such as HDPE drums and intermediate bulk containers (IBC's). It also allows for the use of low levels of Al or Ti modification of the Cr/silica activated catalyst.

In another embodiment, the support is a silica-titania support. Silica-titania supports are well known in the art and are described, for example, in U.S. Pat. No. 3,887,494. Silica-titania supports can also be produced as described in U.S. Pat. Nos. 3,887,494, 5,096,868 and 6,174,981 by “cogelling” or coprecipitating silica and a titanium compound.

Suitable chromium-based catalysts, and in particular titanium-modified chromium-based catalysts, are described, e.g., in Paragraphs [0019]-[0021] of U.S. Patent Publication No. 2020/0055966, which description is incorporated herein by reference.

In a class of embodiments, the chromium-based catalyst may optionally be used with at least one cocatalyst or activator, as noted previously. In general, the cocatalyst may be a metal alkyl of a Group 13 metal. The cocatalyst can be a compound of formula MR₃, where M is a group 13 metal (in accordance with the new numbering scheme of the IUPAC), and each R is independently a linear or branched C₁ or C₂ or C₄ to C₁₂ or C₁₀ or C₈ alkyl group. Mixtures of two or more such metal alkyls are also contemplated, and are included within the term “cocatalyst” as used herein. In various embodiments, M may be aluminum, and the cocatalyst is at least one aluminum alkyl. Aluminum alkyls include triethyl aluminum (TEAl), tri-isobutylaluminum (TIBAl), tri-n-hexyl aluminum (TNHA), tri-n-octylaluminum (TNOA), and mixtures thereof. In another class of embodiments, the at least one aluminum alkyl may be an alkyl aluminum alkoxide compound, such as, for example, diethyl aluminum ethoxide (DEAlE). In any of the embodiments described above, the aluminum alkyl may be pre-contacted with the at least one chromium-containing catalyst at an Al/Cr molar ratio of 0.01 to 10.00, at an Al/Cr molar ratio of 0.05 to 10.00, at an Al/Cr molar ratio of 0.5 to 8.00, at an Al/Cr molar ratio of 0.10 to 8.00, at an Al/Cr molar ratio of 0.10 to 5.00, at an Al/Cr molar ratio of 0.50 to 5.00, or at an Al/Cr molar ratio of 1.00 to 3.00.

### Blends

The present disclosure provides blends of the polyethylene composition(s) prior to being formed into a film, molded part or other article. The blends may optionally include one or more additional polymers. For example, additional polymers may include a polyethylene, an isotactic polypropylene, a highly isotactic polypropylene, a syndiotactic polypropylene, a random copolymer of propylene and ethylene, and/or butene, and/or hexene, poly butene, ethylene vinyl acetate, low density polyethylene (LDPE), linear low density polyethylene (LLDPE), ethylene vinyl acetate, ethylene methyl acrylate, copolymers of acrylic acid, polymethylmethacry late or any other polymers polymerizable by a high-pressure free radical process, polyvinylchloride, polybutene-1, isotactic polybutene, ABS resins, ethylene-propylene rubber (EPR), vulcanized EPR, ethylene propylene diene monomer (EPDM) polymer, block copolymer, styrenic block copolymers, polyamides, polycarbonates, polyethylene terephthalate (PET) resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

An additional polymer may be obtained from a post-consumer recycled (PCR) polymer material.

In at least one embodiment, the polyethylene composition is present in the above blends at 10 wt % to 99 wt %, based upon the weight of the polymers in the blend, such as 20 wt % to 95 wt %, such as 30 wt % to 90 wt %, such as 40 wt % to 90 wt %, such as 50 wt % to 90 wt %, such as 60 wt % to 90 wt %, such as 70 to 90 wt %, such as 80 to 90 wt %, alternatively 90 to 99 wt %, such as 92 to 98 wt %.

The blends described above may be produced by mixing the polymers (and optional additives) of the present disclosure with one or more polymers (as described above), by connecting reactors together in series or in parallel to make reactor blends or by using more than one catalyst in the same reactor to produce multiple species of polymer. The polymers (and optional additives) can be mixed together prior to being put into an extruder or may be mixed in the extruder.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc; or combination(s) thereof.

### Films and Other End Uses

A polyethylene composition of the present disclosure (and/or a blend comprising the polyethylene composition) can be useful in forming various articles, including but not limited to films (monolayer or multilayer, formed by extrusion, co-extrusion, casting, and/or lamination), sheet, and fiber extrusion and co-extrusion; as well as gas-assisted injection molding, extrusion blow molding, injection blow molding, injection stretch blow molding, compression molding, rotational molding, foam molding, thermoforming, sheet extrusion, profile extrusion, machine direction orientation (MDO) polyethylene and biaxial oriented polyethylene (BOPE) films, etc.

Film applications may include, for example, mono-or multi-layer blown, extruded, and/or shrink films. These films may be formed by any number of well-known extrusion or coextrusion techniques, such as, for example, a blown film technique (described in more detail below), wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxial orientation can be accomplished using typical cold drawing or hot drawing methods. Biaxial orientation can be accomplished using tenter frame equipment or a double bubble process and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. For example, the films can be oriented in the Machine Direction (MD) at a ratio of up to 15, such as from about 5 to about 7, and in the Transverse Direction (TD) at a ratio of up to 15, such as from about 7 to about 9. However, in another embodiment the film is oriented to the same extent in both the MD and TD directions.

The films may vary in thickness depending on the intended application; however, films of a thickness from 1 μm to 50 μm, such as 1 μm to 25 μm, such as 1 μm to 12 μm, can be suitable. Films intended for packaging can be from 10 μm to 50 μm thick. The thickness of the sealing layer can be from 0.2 μm to 50 μm. There may be a sealing layer on both the inner and outer surfaces of the film or the sealing layer may be present on only the inner or the outer surface.

Monolayer and multilayer films are contemplated herein, wherein the polyethylene compositions can be suitable for inclusion in any one or more layers of a film (e.g., in skin layers of a 3-layer or 5-layer film; in sub-skin layers of a 5-layer film; in a core or any internal layer in such films; and in any layer of 6+ layer films, etc.).

### Production of Blown Film

Typically a polyolefin composition for blown film applications has an MI of less than 2 (lower MI=higher MW). In order to form blown film, a polyolefin composition is extruded as molten polymer over a circular die and a bubble blows up. The molecular weight of the polyolefin composition should be high enough to form bubble (otherwise there isnt enough stress to form the bubble). In contrast, for cast films, a polyolefin composition should have an MI of 2 to 4 and cannot blow into films (i.e., it needs to be extruded). However, polyolefin compositions of the present disclosure provide a high Mz and a low enough MI such that blown films can be formed, and this can be true even for polyethylene homopolymer compositions. Also, the high density of polyolefin compositions of the present disclosure can provide blown films having good barrier properties (e.g., that keep moisture out when used as food packaging).

Blown film extrusion involves the process of extruding the polyethylene composition (or blends thereof) through a die followed by a bubble-like expansion. Advantages of manufacturing film in this manner include: (1) a single operation to produce tubing; (2) regulation of film width and thickness by control of the volume of air in the bubble; (3) high extruder output and haul-off speed; (4) elimination of end effects such as edge bead trim and nonuniform temperature that can result from flat die film extrusion; and (5) capability of biaxial orientation (allowing uniformity of mechanical properties).

As part of the process, a melt comprising the polyethylene composition (or blend thereof) is mixed with a foaming agent and extruded through an annular slit die to form a thin walled tube. Air is introduced via a hole in the center of the die to blow up the tube like a balloon. Mounted on top of the die, a high-speed air ring blows onto the hot film to cool it. The foam film is drawn in an upward direction, continually cooling, until it passes through nip rolls where the tube is flattened to create what is known as a ‘lay-flat’ tube of film. This lay-flat or collapsed tube is then taken back down the extrusion tower via more rollers. For high output lines, air inside the bubble may also be exchanged. The lay-flat film is either wound or the edges of the film are slit off to produce two flat film sheets and wound up onto reels to produce a tube of film. For lay-flat film, the tube can be made into bags, for example, by sealing across the width of film and cutting or perforating to make each bag. This operation can be performed either in line with the blown film process or at a later time. The blown film extrusion process is typically a continuous process.

In coextrusion lines, the number of extruders depends on the number of different materials being extruded and not necessarily on the number of layers. Current feedblock technology allows fluid flow from one extruder to be split into two or more layers in the coextrudate. In an aspect, a coextrusion feedblock arranges the different melt streams in a predetermined layer sequence and generates a melt stream for each layer. Each melt stream then meets its neighboring layers and a final planar coextrudate is formed. The coextrusion feedblock can be fixed or have variable geometry blocks. A flat die, and the synergy between the die and the feedblock, can be important in high quality film production. The die should spread the coextrudate received from the feedblock while maintaining flatness of the film. The residence time of polymer melt moving through the die is preferably short enough to prevent heat transfer between layers or polymer degradation. The die should also be sufficiently strong so as to resist deformation when subjected to high pressures inherent in thin film processes.

### Film Properties

As noted, a significant reason for employing the new design is the benefit in running at low die pressure, which can desirably increase possible maximum output rate achievable while maintaining the film properties. More specifically, employing the present polyethylene compositions can provide a beneficial decrease of die pressure before and/or after screenpack (of at least 5%, preferably at least 10% or even 20%) as compared to processing a comparator resin that yields a film having otherwise similar properties. As used herein, a comparator resin yielding a film having otherwise similar properties means a resin that results in a film having identical structure to a film made using the present polyethylene composition, and which has one or more of (and preferably all of):
1% secant modulus (MD) within +/−10% psi, preferably within +/−5% psi, of the value (psi) of a film that is made using the presently described polyethylene composition, but is otherwise identical;
Gloss within +/−10%, preferably within +/−5%, of the value (in %) of a film that is made using the presently described polyethylene composition, but is otherwise identical;
Oxygen transmission rate (OTR) within +/−20%, preferably within +/−15%, of the value (g) of a film that is made using the presently described polyethylene composition, but is otherwise identical;
Water vapor transmission rate (WVTR) within +/−20%, preferably within +/−15%, of the value (g) of a film that is made using the presently described polyethylene composition, but is otherwise identical;
Yield strength (MD) within +/−10%, preferably within +/−5%, of the value (in GU) of a film that is made using the presently described polyethylene composition, but is otherwise identical; and
Tensile strength (MD) within +/−15%, preferably within +/−10% of the value (g) of a film that is made using the presently described polyethylene composition, but is otherwise identical.

### Other Articles

Polyethylene compositions (or blends thereof) may be used to prepare nonwoven fabrics and fibers in any nonwoven fabric and fiber making process, including but not limited to, melt blowing, spun-bonding, film aperturing, and staple fiber carding. Examples include continuous filament processes, spun-bonding processes, and the like. The spun-bonding process involves the extrusion of fibers through a spinneret. These fibers are then drawn using high velocity air and laid on an endless belt. A calender roll is generally then used to heat the web and bond the fibers to one another although other techniques may be used such as sonic bonding and adhesive bonding.

Polyethylene compositions (or blends thereof) according to embodiments disclosed herein are also useful in a wide variety of applications such as automotive overshoot parts (e.g., door handles and skins such as dashboard, instrument panel and interior door skins), house tool handles, airbag covers, toothbrush handles, shoe soles, grips, skins, toys, appliance moldings and fascia, gaskets, furniture moldings and the like.

Other articles of commerce that can be produced include but are not limited by the following examples: awnings and canopies--coated fabric, tents/tarps coated fabric covers, curtains extruded soft sheet, protective cloth coated fabric, bumper fascia, instrument panel and trim skin, coated fabric for auto interior, geo textiles, appliance door gaskets, liners/gaskets/mats, hose and tubing, syringe plunger tips, light weight conveyor belt PVC replacement, modifier for rubber concentrates to reduce viscosity, single ply roofing compositions, recreation and sporting goods, grips for pens, razors, toothbrushes, handles, and the like. Other articles include marine belting, pillow tanks, ducting, dunnage bags, architectural trim and molding, collapsible storage containers, synthetic wine corks, IV and fluid administration bags, examination gloves, and the like.

In some embodiments, to make filaments and consequently non-woven fabrics of the present disclosure, a first step is to spin the fiber or filaments. Polyethylene compositions (or blends thereof) are fed into an extruder for melting and metering. The extruder parameters such as barrel and screw size and operating conditions such as temperature setting and screw RPM are known to skilled persons in the art. The melt is metered to pass the spinneret that has orifices. The number of the orifices depends on the size of equipment. The emitting filaments consequently attenuated (draw in machine direction) and cooled. In a spunbond process the filaments laydown on the moving belt to form un-bonded fabrics. One example to bond the unbonded fabric is called thermal point bonding which employs one smooth roll and one engrave roll. In addition to the spunbond process that is a continuous in-line from resin to fabric process, the filament may be collected in batches for subsequent processes such as cutting, carding and fabric forming and bonding processes. In another embodiment, when using an additional extruder and appropriate die arrangement and adapters, polyethylene compositions (or blends thereof) are coextruded with other polymers including but not limited to PET and polypropylene, to make bi-component fibers in core/sheath or side by side geometry. The resulting fabrics may have many applications from construction liners, house wrap membranes, hygiene, among others.

### EXAMPLES

### Polymerization Process Description

Example homopolyethylene compositions per Table 2 were formed in a slurry loop polymerization reactor with ethylene fed as monomer, using a chrome-based catalyst in accordance with the catalyst description in A Review of the Phillips Chromium Catalyst for Ethylene Polymerization, Ch.13 in HANDBOOK OF TRANSITION METAL POLYMERIZATION CATALYSTS (2d Ed. 2018, John Wiley & Sons, Inc.). Reactor temperature, ethylene wt %, and hydrogen to diluent (isobutane) feed ratio conditions are set forth in Table 1. After the polymerization process, the resulting slurry was separated from the diluent and dried.

TABLE 2
Example Process Conditions

| Samples vs. Process Set Points | CE4 | IE1 | IE2 |
|---|---|---|---|
| Reactor Temperature (degF.) | 225.5 | 226 | 226 |
| Reactor C2 | 4.25 | 3.2 | 3.1 |
| (wt %) | | | |
| Hydrogen to diluent feed ratio | 225 | 225 | 300 |
| (wtppm) | | | |

Prior to blown film extrusion, 500 ppm primary AO Irganox 1010, 1000 ppm secondary AO Irgafos 168 were blended with the resins and compounded by using a twin screw extruder. No nucleating agents were used.
CE1 is HTA108, a unimodal HDPE available from ExxonMobil Product Solutions.
CE2 SURPASS™ HPs167-AB, a bimodal HDPE available from Nova Chemicals.
CE3 is HD7845.30 HDPE, a bimodal HDPE available from ExxonMobil Product Solutions.
CE4, IE1 and IE2 are experimental HDPE resins made as described above and in conjunction with Table 1.
CE5 and CE6 are unimodal HDPE resins with low MIR (MIR<50) made as described in the examples of WO2023/081577 (labeled therein as IE1 and IE2).

Table 3 below reports the properties of the example HDPE resins produced as described above, along with properties measured on the various comparative example resins just listed.

TABLE 3
Properties of Example HDPE Resins

| | CE1 | CE2 | CE3 | CE4 | CE5 | CE6 | IE1 | IE2 |
|---|---|---|---|---|---|---|---|---|
| MI | 0.74 | 1.25 | 0.46 | 0.75 | 0.7 | 2.7 | 1.2 | 1.3 |
| HLMI | 47.5 | 67.6 | 30 | 56.6 | 24 | 91 | 77 | 81 |
| MIR | 64.2 | 54.1 | 65.2 | 75.5 | 34 | 34 | 64.5 | 62.1 |
| Density | 0.961 | 0.968 | 0.958 | 0.9630 | 0.962 | 0.966 | 0.9639 | 0.9638 |
| Melting Point | N/A | N/A | N/A | 134.9 | n/a | 136.3 C. | 134.4 | 134.9 |
| vinyl/ | 0.79 | N/A | N/A | 0.86 | 0.1 | N/A | 0.89 | 0.86 |
| 1000TC | | | | | | | | |
| Crossover | 47.5 | 50 | 25.3 | 27.2 | 103.9 | 294 | 63 | 70.3 |
| frequency | | | | | | | | |
| rad/s | | | | | | | | |
| Cross over | 0.057 | 0.10 | 0.061 | 0.037 | 0.12 | 0.1 | 0.048 | 0.050 |
| modulus Mpa | | | | | | | | |
| η 0.01 1/s | 32,914 | 9,268 | 32,868 | 42,226 | 15432.0 | 5349.0 | 27415.3 | 24644.7 |
| η 0.1 1/s | 18904.0 | 7854.0 | 22797.0 | 20693.0 | 12023.0 | 4568.0 | 14139.6 | 13503.5 |
| η 100 1/s | 1167.0 | 760.6 | 1609.9 | 990.0 | 1634 | 955 | 855.8 | 844.1 |
| η 628 1/s | 390.9 | 342.0 | 492.0 | 345.0 | 561 | 628 | 310.4 | 308.3 |
| phase angle at | 33.1 | 24.0 | 28.5 | 34.3 | 32.6 | 39.1 | 36.2 | 36.3 |
| 628 1/s | | | | | | | | |
| ZSV(Pa*s) | 250,948 | 10,931 | 56,916 | 870,406 | 22,196 | 6,561 | 544,603 | 296,492 |
| Mn (LS) | 11,058 | 9,991 | 17,954 | 15,964 | 22,839 | 16,666 | 15,376 | 14,437 |
| Mw(LS) | 144,297 | 104,757 | 240,964 | 125,894 | 229,070 | 171,424 | 128,714 | 116,522 |
| Mz(LS) | 1,136,965 | 314,750 | 1,450,281 | 926,768 | 1,616,181 | 1,623,185 | 1,000,649 | 949,232 |
| Mw/Mn | 13.0 | 10.5 | 13.4 | 7.9 | 10.0 | 10.3 | 8.4 | 8.1 |
| Mz/Mw | 7.9 | 3.0 | 6.0 | 7.4 | 7.1 | 9.5 | 7.8 | 8.1 |
| g′ | 0.96 | 1.0 | 0.74 | 0.94 | 0.73 | 0.73 | 0.93 | 0.95 |

With respect to shear viscosity and melt index ratio (MIR), one can see the expected result when reviewing CE5 and CE6 as compared to the other samples (including IE1 and IE2) in Table 3; having a much lower MIR, CE5 and CE6 exhibit much higher viscosity at higher shear rates associated with processing conditions (n 100 and n 628 values) as compared to the other resins (which have higher MIR). This is not surprising, since the low-MIR CE5 and CE6resins are made using Ziegler-Natta catalysts and therefore are expected to have substantially more linearity and less variation in molecular weight chains, ergo lower MIR and higher viscosity (more difficult processing). Thus, we confirm that the field of useful comparison for good-processing resins is narrowed to the higher-MIR CE1-CE4 and IE1-IE2.

Nonetheless, it is also interesting to note that, among those high MIR/good-processing resins, only IE1 and IE2 have similarly high COF (crossover frequency) to CE5 and CE6, indicating that while the IE1 and IE2 resins process well with relatively low viscosity, at the same time their molecular architecture is such that they more readily relax than would be expected for their MIR and molecular weight characteristics. On the whole, then, the IE1 and IE2 resins are expected to exhibit a combination of easy processing and good balance of properties (especially in both the machine-direction (MD) and transverse-direction (TD)) as compared to the lower-COF/high MIR resins, and as compared to the higher-COF/low MIR resins.

That is, IE1 and IE2 exhibit a unique combination of high MIR and high COF relative to their weight average molecular weight (Mw), which provides advantages in such resins' processing and balance of properties of films made therefrom.

### Film Extrusion

Samples IE1, and IE2 were converted into monolayer films using an Alpine blown film line equipped with 90 mm screw, 160 mm OD die, 60 mil die gap, zone temperatures were set to between 420 to 435° F., with blow-up ratio (BUR) equal to 2.5, frost line height about 22 to 24 inches, output about 10 lbs/hr per inch die. Melt temperature was kept at about 380° F. Films with 1 mil nominal thickness were made. 1 mil film of CE4 was fabricated by using a Gloucester Blown film line equipped with a 2.5″screw, extrusion conditions and output rates are similar as just noted for IE1 and IE2.

Film tensile properties were obtained per ASTM D882. Film 1% secant modulus properties were obtained per ASTM D882. Film tear properties were obtained per ASTM D1922. Film optical properties were obtained per ASTM D1003.

Duplicate monolayer film samples extruded as described above were cut into about 10 cm×about 10 cm for MVTR measurement, the exposed area for testing was 50 square centimeters according to ASTMF1249. 5 thickness measurements were made and average was used for calculation. The testing temperature was fixed at 37.8° C. Other testing procedures were according to ASTM F1249.

Table 4 illustrates physical properties and barrier properties of films made from the HDPE resin samples indicated.

TABLE 4
Properties of Example Films

| | CE4 | IE1 | IE2 |
|---|---|---|---|
| Film Rigidity Secant Modulus | | | |
| 1% Secant Modulus (psi) | | | |
| MD | 171,000 | 166,000 | 164,000 |
| TD | 226,000 | 222,000 | 219,000 |
| Film Gauge | | | |
| Average Gauge (mil) | | | |
| Average | 0.987 | 0.975 | 0.97 |
| Minimum | 0.886 | 0.895 | 0.817 |
| Maximum | 1.135 | 1.085 | 1.079 |
| Gloss 45° | | | |
| Gloss 45° @ MD (GU) | 11.7 | 12 | 12 |
| Gloss 45° @ TD (GU) | 12 | 12 | 13 |
| Film/Sheeting Tensile | | | |
| Yield Strength (psi) | | | |
| MD | 4,870 | 4,790 | 4,610 |
| TD | 4,350 | 4,730 | 4,450 |
| Elongation at Yield (%) | | | |
| MD | 2.9 | 2.5 | 2.7 |
| TD | 2.5 | 2.1 | 2.4 |
| Tensile Strength (psi) | | | |
| MD | 6,630 | 6,610 | 6,200 |
| TD | 4,690 | 5,150 | 4,750 |
| Elongation at Break (%) | | | |
| MD | 360 | 430 | 460 |
| TD | 5.1 | 4.3 | 5 |
| Oxygen transmission rate, | 2,837 | 2,876 | 2,509 |
| OTR (CC* mil/ | | | |
| (m²*day) | | | |
| Water vapor transmission rate, | 11.7 | 13.7 | 11.2 |
| WVTR (g* mil/ | | | |
| (m²*day) | | | |

Table 5 illustrates film processing conditions in the blown extrusion. Employing the new design has the benefit of running at low die pressure, which means the inventive examples would be capable of running at increased output rate while still maintaining the strong film properties. More specifically, the inventive resins IE1 and IE2 exhibited >14% decrease in die pressure before screenpack, as compared to CE4, while maintaining good blown film properties. Likewise, IE1 and IE2 exhibited 5-10% decrease in die pressure after screenpack as compared to CE4, again while maintaining excellent and well-balanced film properties in both MD and TD.

TABLE 5
Film Processing Conditions

| | CE4 | IE1 | IE2 |
|---|---|---|---|
| Die pressure before screenpack (PSI), | 5,208 | 4,472 | 4,467 |
| average | | | |
| Die pressure after screenpack (PSI), | 3660 | 3,454 | 3,320 |
| average | | | |
| Die melting temperature (° F.), average | 382.5 | 381.0 | 380.7 |
| Percentage of die pressure before screenpack | n/a | 14.1 | 14.2 |
| decrease (% vs CE4) | | | |
| Percentage of die pressure after screenpack | n/a | 5.6 | 9.7 |
| decrease (% vs CE4) | | | |

### Further Analysis

Further analysis was carried out to determine whether the molecular architecture of the inventive samples contributed to the combination of good processability while still achieving desired stiffness, optical, and strength goals of the films made therefrom. One useful test indicates the presence and degree of long-chain branching (LCB) in a polyethylene composition (especially a HDPE composition) with sparse, but present, LCB, as described in paragraph of WO2019/046085 and in Janzen and Colby, Diagnosing long-chain branching in polyethylenes, J. MOL. STRUCT., vol. 485-486, p. 569 (Aug. 10, 1999), wherein zero-shear viscosity (η0, the shear viscosity in the limit of zero shear rate) is plotted against M_{w} of the PE resin according to the following relationship;

$$η 0 = ( K ) ( {M}_{w}^{3.4} ) exp ( E / RT )$$

where the 3.4 power law index was first reported by Fox and Flory in J. Phys. Chem. 1951, 55, 2, 221-234. R is the gas constant, and T is the absolute temperature. E is the flow activation energy. This ZSV and Mw correlation can be simplified, as described in WO2019/046085 and in Janzen and Colby, to an LCB test, such that linear PE would be expected to have η0/Mw^{3.4} ratio of approximately 5.8E−14 (per Janzen & Colby), or 3.66E−14 (per Table 4 of Locati et al., A Model for the Zero Shear Viscosity, J. POLYMER ENG'G AND SCI., vol. 39 (No. 4), p. 741 (April 1999)). On or below this reference, HDPE would be expected to have little or no LCB; above the reference, greater amounts of LCB. The values Eta0/Mw^{3.4} of the tested resins are reported below in Table 6, where it can be seen that all resins except CE1, CE4, IE1, and IE2 have values in general agreement with linear PE as deduced in the above references; while CE4, IE1, and IE2 all exhibit moderate LCB characteristics (with CE1 exhibiting minor departure from expected linearity). Thus it would appear that the inventive resins and CE4 exhibit similar LCB architecture.

TABLE 6
η0/Mw^{3.4} values for LCB Determination

| | CE1 | CE2 | CE3 | CE4 | CE5 | CE6 | IE1 | IE2 |
|---|---|---|---|---|---|---|---|---|
| η 0/Mw^{3.4} | 7.2E−13 | 9.3E−14 | 2.9E−14 | 4.0E−12 | 1.3E−14 | 1.0E−14 | 2.3E−12 | 1.8E−12 |

Moreover, further to the discussion above, the unique rheology of the present inventive examples was further investigated through study of the crossover frequency (COF) as a function of weight-average molecular weight (Mw), so as to determine further distinctions that could explain superior processing with respect to CE4 (which also exhibited LCB, per above). It was found that the inventive examples IE1 and IE2 stood out as compared to all other tested resins with high MIR (i.e., resins CE1-CE4) by exhibiting relatively high COF for their Mw, in particular by following the below relationship:

$$COF > - 0.00015 ( Mw ) + 80$$

where COF is in rad/s; Mw is weight-average molecular weight in g/mol; it can therefore readily be seen that the −0.00015 constant has units rad/s/(g/mol), and the 80 constant has units rad/s.

FIG. 1 shows a plot of this line (with COF on the Y axis; Mw on the X axis) along with the high-MIR resins CE1-CE4, illustrating that among the high-MIR resins, only IE1 and IE2 meet this parameter, illustrating their balance of moderate LCB with balanced loss and storage moduli, while maintaining high MIR and good processability. Again, this is expected to yield benefits in maintaining good film properties, and especially balanced properties between MD and TD, even while having such good processability.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise, whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

We claim:

1. A polyethylene composition comprising 80 wt % or greater ethylene-derived units and having the following properties:
a. Density within the range from 0.940 to 0.975 g/cm3;
b. melt index (MI, 2.16 kg loading, 190° C.) within the range from 0.5 g/10 min to 2.5 g/10 min;
c. high load melt index (HLMI, 21.6 kg loading, 190° C.) within the range from 60 g/10 min to 150 g/10 min;
d. a melt index ratio (MIR, defined as HLMI/MI) within the range from 50 to 100; and
e. a crossover frequency (COF) in accordance with the following: COF>−0.00015*(Mw)+80 (where COF is in rad/s and Mw is weight-average molecular weight in g/mol).

2. The polyethylene composition of claim 1, wherein the polyethylene composition is unimodal.

3. The polyethylene composition of claim 1, wherein the polyethylene composition has long-chain branching.

4. The polyethylene composition of claim 3, wherein the long chain branching is evidenced by a ratio of η0/Mw^{3.4} within the range from 1E−13 to 3E−12, where η0 is zero-shear viscosity and Mw^{3.4} is weight-average molecular weight raised to the power of 3.4.

5. The polyethylene composition of claim 1, further having one or more of the following properties:
f. a phase angle at 628 rad/s greater than 35°;
g. 0.4 to 1 vinyl/1000 total carbons;
h. weight average molecular weight (Mw) within the range from 100,000 g/mol to 220,000 g/mol;
i. number average molecular weight (Mn) within the range from 10,000 to 20,000 g/mol; and
j. molecular weight distribution (Mw/Mn) within the range from 5 to 15.

6. The polyethylene composition of claim 5, having all of the properties (f)-(j).

7. The polyethylene composition of claim 1, having MI within the range from 1.0 to 2.0 g/10 min, HLMI within the range from 70 to 100 g/10 min, and MIR within the range from 60 to 80.

8. A method of making a polyethylene composition, the method comprising:
a. Introducing ethylene, an optional comonomer, a diluent, and a catalyst to a loop reactor under conditions sufficient to produce a slurry comprising the polyethylene composition;
b. continuously or periodically discharging a portion of the slurry from the loop reactor as an effluent comprising the polyethylene composition; and
c. flashing the effluent to vaporize the diluent and thereby form a concentrated effluent comprising the polyethylene composition;
wherein the polyethylene composition comprises 80 wt % or greater ethylene-derived units and has density within the range from 0.940 to 0.975 g/cm³; melt index (MI, 2.16 kg loading, 190° C.) within the range from 0.5 g/10 min to 2.5 g/10 min; high load melt index (HLMI, 21.6 kg loading, 190° C.) within the range from 60 g/10 min to 150 g/10 min; melt index ratio (MIR, defined as HLMI/MI) within the range from 50 to 100; and a crossover frequency (COF) in accordance with the following: COF>−0.00015*(Mw)+80 (where COF is in rad/s and Mw is weight-average molecular weight in g/mol).

9. The method of claim 8, wherein the polyethylene composition has a ratio of η0/Mw^{3.4} within the range from 1E−13 to 3E−12, where η0 is zero-shear viscosity and Mw^{3.4} is weight-average molecular weight raised to the power of 3.4.

10. A blown film made from the polyethylene of claim 1.
